(19) United States
(12) Patent Application Publication
(10) Pub. No.: US 2006/0007564 A1
(43) Pub. Date: Jan. 12, 2006

(54) Lens holder for lens device and process of assembring lens device equipped with the lens holder

(75) Inventors: Kenichi Sakamoto, Saitama-Shi (JP); Tomonari Masuzawa, Saitama-Shi (JP)

Correspondence Address: YOUNG & THOMPSON, 745 SOUTH 23RD STREET, 2ND FLOOR, ARLINGTON, VA, 22202, US

(73) Assignee: FUJINON CORPORATION, SAITAMA-SHI (JP)

(21) Appl. No.: 11/174,646

(22) Filed: Jul. 6, 2005

(30) Foreign Application Priority Data
Jul. 6, 2004 (JP) 2004-199256

(51) Int. Cl. G02B 7/02

(52) U.S. Cl. 359/819

(57) ABSTRACT

A lens device includes a plurality of lens groups, a lens holder for holding each lens group, a cam barrel for receiving the lens holder therein so as to allow axial movement of the lens holder, and a cam mechanism having cam slots formed in the cam barrel and cam followers provided on the lens holder in slide engagement with the cam slots, respectively, through which rotation of the cam barrel causes the axial movement of the lens holder. The lens holder includes a lens mounting frame for fixedly mounting the lens group therein; and a union collar fixedly coupled to the lens mounting frame; and the cam followers are fix to the union collar.

### BACKGROUND OF THE INVENTION

1. Field of the Invention

The present invention relates to an optical lens device including a plurality of lens groups movably mounted in a cam barrel so as to move in an axial direction following rotation of the cam barrel, and, more particularly, to improvement of a structure of a lens holder for mounting a lens group in a cam barrel, and a process of assembling the lens device.

2. Description of Related Art

Various types of zoom lenses are nowadays widely used for optical instruments such as photographic cameras and optical projectors. Such a zoom lens comprises an optical lens system consisting of a plurality of lens groups and lens barrels mounting the lens groups therein so as to cause relative movement of the lens groups in an axial direction for focusing and zooming by rotating one or more lens barrels. Each lens group consisting of one or more optical lens elements is fixedly held in a lens holder provided with a plurality of, for example three, cam followers disposed at regular angular intervals and extending radially from the peripheral surface of the lens holder. The lens barrels include a zooming cam barrel having zooming cam slots and a stationary cam barrel having rectilinear guide cam slots. These zooming cam slots and rectilinear guide slots receive the cam followers of the lens holder, respectively, so as to move the lens holder rectilinearly in an axial direction according to rotated angles of the zooming cam barrel. Zoom lenses of this type are known from, for example, Published Japanese Patent Application Nos. 11-326734 and 2000-321476.

In order to form high quality images, the zoom lens should consists of lens groups precisely aligned an optical axis of the zoom lens system. It is essential for achieving such precise alignment of the lens groups to mount each lens group in a lens holder formed with high parallelism and having cam followers arranged precisely in position The lens holder is generally formed of plastic using injection molding. Because the lens holder has an undercut between a lens holding portion and a cam follower mounting portion, it is conventional to use slide molds in the injection molding.

Since the injection molding with slide molds encounters not only deterioration in molding accuracy, it has been hard to mold a lens mounting member and cam followers of the lens holder with high accuracy but also an increase in molding cost.

### SUMMARY OF THE INVENTION

It is therefore an object of the present invention to provide a high precision, low cost lens holder for a lens device that is capable of being installed in a lens barrel with high accuracy.

The foregoing object is accomplished by a lens holder comprising a lens mounting frame for fixedly mounting a lens or a lens group therein and a union collar coupled to the lens mounting frame. The union collar is provided with a plurality of cam followers arranged on an outer periphery thereof. The union collar and the lens mounting frame are coupled to each other preferably by press-fitting. Otherwise, the union collar and the lens mounting frame may be coupled together through coupling means such as comprising retainer claws formed on either one of the lens mounting frame and the union collar and flexible hooks formed on the other or comprising projections extending radially outward from both lens mounting frame and union collar and resilient fasteners for fastening respective pairs of the projections of the lens mounting frame and the union collar, or may be coupled together with an adhesion bond or set screws.

The process for assembling the lens device equipped with the lens holder includes the steps of assembling the union collars into a cam barrel and fixedly coupling the lens mounting frames with lens groups fixedly mounted therein, respectively, to the union collars together, respectively. Upon assembling the union collars into the cam barrel, the union colors are detachably mounted on a fixture in predetermined positions, respectively, and assembled into the cam barrel by inserting and snugly fitting the fixture in predetermined axial position in the cam barrel.

According to the lens holder for a lens device that comprises the lens mounting frame for fixedly mounting a lens or a lens group therein and the union collar with cam followers prepared separately eliminates the use of slide molds for formation of the lens holder, realizes high accuracy, low cost lens holders and easily improves optical performance of the lens device. Further, since the union collar is provided commonly to lens holders for a plurality of lenses or lens groups, it is realized to reduce initial cost. Furthermore, in the case where a lens group has high sensitivity on its optical design, the separate structure of the lens holder enables eccentricity adjustment between the lens mounting frame and the union collar, so that fine optical axis alignment of the lens device is accomplished. This leads to enhanced image quality. Coupling of the lens mounting frame and the union collar is easily achieved by press-fitting, a simple structure of coupling means, adhesion bond or set screws.

Since the assembling process comprises the steps of assembling the union collars into a cam barrel and, thereafter, fixedly coupling the lens mounting frames to the union collars together, the union collar is assembled to the cam barrel with high accuracy, so that the lens mounting frame and the cam barrel are coupled with increased accuracy. The use of the fixture upon assembling a plurality of the union collars to the cam barrel enables easy positional adjustment between the cam barrel and the union collars and between the union collars themselves.

### BRIEF DESCRIPTION OF THE DRAWINGS

The foregoing and other objects and features of the present invention will be clearly understood from the following detailed description when reading with reference to the accompanying drawings, wherein the same reference signs have been used to denote same or similar parts throughout the drawings, and in which:

FIG. 1A is a cross sectional view of an image projection unit including a zoom lens according to an embodiment of the present invention;

FIG. 1B is an enlarged cross sectional view of a cam followers of a zooming cam barrel;

FIG. 1C is an enlarged cross sectional view of a coupling structure between a lens mounting frame and a union collar of a lens holder,

FIG. 1D is an enlarged cross sectional view of a cam followers of a union collar of a lens holder,

FIG. 2 is an exploded perspective view of lens barrels and its associated parts for a zooming mechanism;

FIG. 3 is an exploded perspective view of a lens holder for a second lens group;

FIG. 4 is an exploded perspective view of a lens holder for a third lens group;

FIG. 5 is a flowchart illustrating a process of assembling the zoom lens;

FIG. 6 is a perspective view of an external appearance of a fixture used in the zoom lens assembling process;

FIG. 7 is a perspective view showing the step of assembling union collars into a zooming cam barrel;

FIG. 8 is a cross sectional view showing the step of assembling cam followers to the union collars;

FIG. 9 is a cross sectional view showing the step of assembling second and third lens mounting frame to the union collars; and

FIGS. 10A through 10D are cross-sectional views showing alternative coupling structures for coupling a lens mounting frame and a union collar together.

### DETAILED DESCRIPTION OF THE PREFERRED EMBODIMENTS

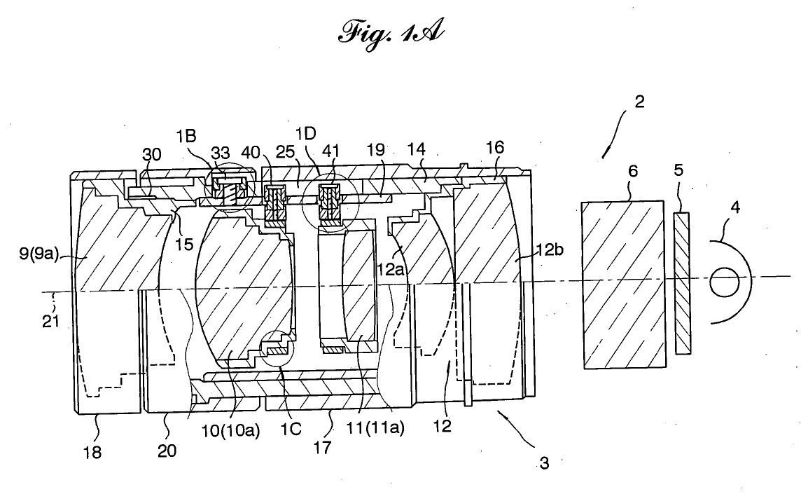

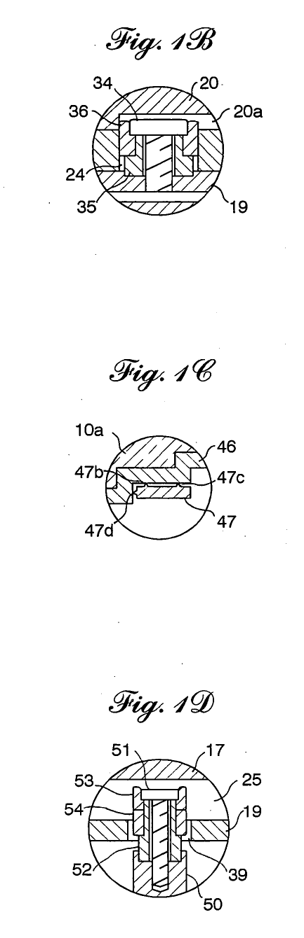

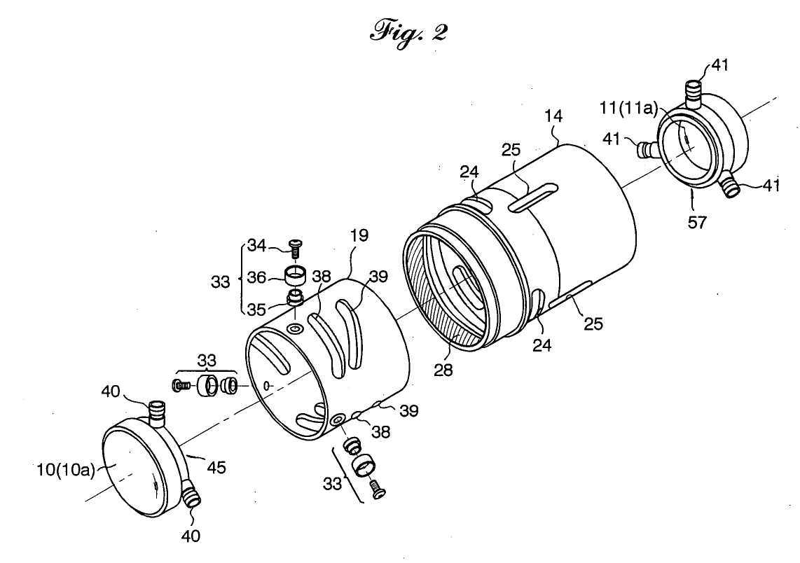

Referring to the accompanying drawings in detail, and in particular, to FIGS. 1A through 1D showing an image projection unit 2 of a projector (not shown), the image projection init 2 comprises a zoom lens 3, a dichroic prism 4, a transmission image display 5 such as a liquid crystal display (LCD), and a projection lamp 6. Light emanating from the projection lamp 5 filters out the transmission image display 5 and impinges on the dichroic prism 4. Three primary color images (R, G and B images) displayed on the transmission image display 5 are combined as a color image by the dichroic prism and projected by the zoom lens 3 onto a screen remote from the projector. The zoom lens 3 has a zoom lens system comprising four lens groups, namely a first lens group 9 comprising a lens 9a that that is operative as a front converter or focusing lens, a second lens group 10 comprising a lens 10a that is operative as a variater lens, a third lens group 11 comprising a lens 11a that is operative as a compensator lens, and a fourth lens group 12 comprising first and second lenses 12a and 12b that are operative as a relay lens. The zoom lens system is mounted within a lens barrel including a stationary lens barrel 14, a focusing lens barrel 15, a relay lens barrel 16, an external barrel 17, a manually operative focusing ring 18, a zooming cam barrel 19 and a manually operative zooming ring 20. The zoom lens 3 is detachably mounted to the projector including the dichroic prism 4, the transmission image display 5 and the projection lamp 6 through the external barrel 17. It is preferred that the zoom lens 3 is mounted so that the external barrel 17 is hidden inside the projector housing. Zooming is performed by manually rotating the zooming ring 20 so as to move the second lens group 10 and the third lens group 11 relatively to each other in an axial direction Focusing is performed by manually rotating the focusing ring 19 so as to move the first lens group 9 in an axial direction.

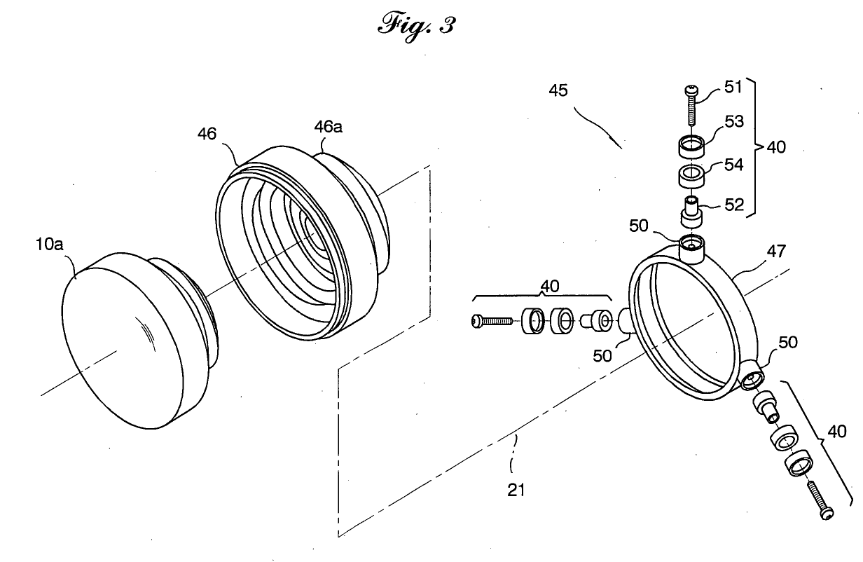

Referring to FIG. 2, the stationary barrel 14 has three circumferential zooming cam slots 24 arranged at regular angular intervals in a circumferential direction in the wall, and three rectilinear axial guide slots 25 extending axially and arranged at regular angular intervals in a circumferential direction in the wall. The zooming cam barrel 19 has three circumferential zooming cam slots 38 arranged at regular angular intervals in a circumferential direction in the wall for the second lens group 10 and three circumferential zooming cam slots 39 arranged at regular angular intervals in a circumferential direction in the wall for the third lens group 10. The stationary barrel 14 holds the first lens group 9 and the fourth lens group 12 at its front and rear ends, respectively. Specifically, the first lens group 9, namely the focusing lens 9a, is fixedly mounted in the focusing lens barrel 15. The fourth lens group 12, namely the relay lenses 12a and 12b, is fixedly mounted in the relay lens barrel 16. The focusing lens barrel 15 is rotationally and axially movably mounted within the stationary barrel 14 through helicoid coupling between external helicoid 30 threads on a rear wall of the focusing lens barrel 15 and internal helicoid threads on a front wall of the stationary barrel 14. The focusing ring 18 fixedly mounted on the focusing lens barrel 15 is manually operated to rotate the focusing lens barrel 15 so as to move the focusing lens 9a back and forth in an axial direction for focusing the zoom lens 3 on an intended object. The focusing lens barrel 15 is prevented from coming off from the stationary barrel 14 in a well known manner. The stationary barrel 14 and the relay lens barrel 16 are fixedly mounted within the external barrel 17.

The zooming cam barrel 19 is provided with three cam followers 33 arranged at regular angular intervals in a circumferential direction in the wall and is rotationally mounted within the stationary barrel 14. The cam followers 33 are received for slide movement in the circumferential zooming cam slots 24 of the stationary barrel 14. Each of the cam followers 33 comprises a cam follower seat 35 secured to the zooming cam barrel 19 by a set screw 35 and a cam follower roller 36 supported for rotation between the cam follower seat 35 and the set screw 34. The cam follower roller 36 rotates within the circumferential zooming cam slot 24 so as to allow smooth slide movement of the cam follower 33 in the circumferential zooming cam slot 24 during relative rotation between the zooming lens barrel 19 and the stationary barrel 14. As shown in FIG. 1B. The cam follower 33 extends passing through the circumferential zooming cam slot 24 of the stationary barrel 14 and is received for slide movement in a rectilinear axial groove 20a formed in the interior wall of the zooming ring 20. The zooming ring 19 is manually operated to rotate the zooming cam barrel 19, so as thereby to move the zooming cam barrel 19 back and forth in an axial direction according to relative angular positions of the zooming cam barrel 19 relative to the stationary barrel 14.

The second lens group 10, namely the lens 10a, is fixedly mounted in a lens holder 45 provided with three cam followers 40 arranged at regular angular intervals in a circumferential direction on the external wall as will be described in detail later. The cam followers 40 extend passing through the circumferential zooming cam slots 38 of the zooming cam barrel 19, respectively, and are received in the rectilinear axial guide slots 25, respectively. Similarly, the third lens group 11, namely the lens 11a, is fixedly mounted in a lens holder 57 provided with three can followers 41 arranged at regular angular intervals in a circumferential direction on the external wall as will be described in detail later. The cam followers 41 extend passing through the circumferential zooming cam slots 39 of the zooming cam barrel 19, respectively, and are received in the rectilinear axial guide slots 25, respectively. Relative rotation between the zooming cam barrel 19 and the stationary barrel 14 that is caused by manual operation of the zooming ring 20 causes axial movement of the second and third lens holders 45 and 57, and hence the second and third lenses 10a and 11a, independently according to angular positions of the cam followers 40 and 41 with respect to the circumferential zooming cam slots 38 and 39, respectively. As a result, the second and third lens groups 10 and 11 move in an axial direction so as thereby to change an axial distance therebetween for linearly varying the focal length of the zoom lens system.

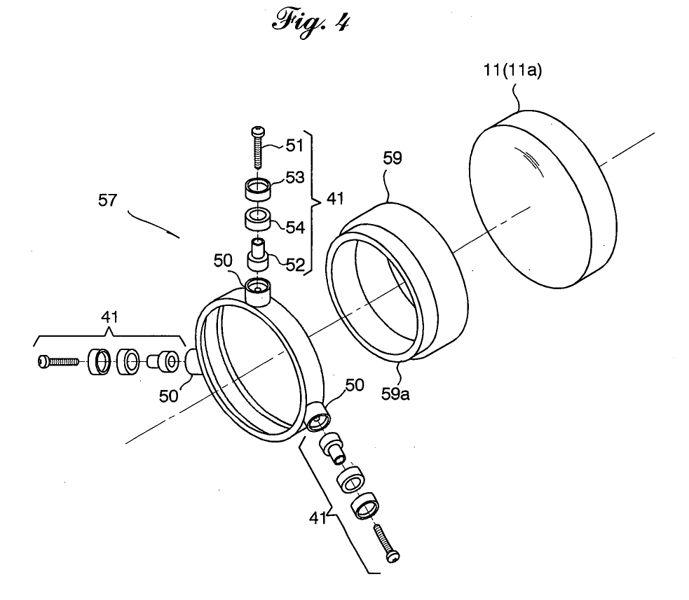

Referring to FIG. 3, the lens holder 45 for the second lens group 10 comprises a generally cylindrically-shaped lens mounting frame 46 having a tail covert 46a formed as one integral piece so as to fixedly mount the lens 11a therein and a union collar 47. The union collar 60 is tightly coupled to the cylindrical lens mounting frame 46 together by press-fitting the union collar 47 onto the tail covert 46a as will be described later. Further, the lens holder 45 is provided with three cam followers 40 arranged at regular angular intervals in a circumferential direction on the external wall of the annular coupling frame 47. Each of the corn followers 40 comprises upper and lower cam follower rollers 53 and 54 which are supported for rotation a cam seat 52 by a set screw a set screw 51 engaged with a threaded boss 52 secured to the external wall of the union collar 47. The upper and lower cam follower rollers 53 and 54 rotate independently within the circumferential zooming cam slot 38 of the zooming cam barrel 19 and the rectilinear axial guide slots 25 of the stationary barrel 14, respectively, so as thereby to allow smooth slide movement of the cam follower 40 in the circumferential zooming cam slot 38 and the rectilinear axial guide slots 25.

The union collar 47 is press fitted onto the cylindrical lens mounting frame 46. As shown in FIG. 1C, the annual frame 47 is provided with circumferential protrusions 47b and 47c formed over the internal wall thereof. Each of the circumferential protrusions 47b and 47c has an external diameter slightly smaller than an external diameter of the tail covert 46a of the cylindrical lens mounting frame 46 so as to be coupled to the tail covert 46a through shrink fitting. Further, the annual frame 47 is provided with circular protrusions 47d formed on the end wall thereof. The circular protrusion 47d is brought into abutment against a vertical shoulder of the lens mounting frame 46a so as thereby to position the union collar 47 in the axial direction with respect to the lens mounting frame 46.

Referring to FIG. 4, the lens holder 57 for the third lens group 11 comprises a generally cylindrically-shaped lens mounting frame 59 having a tail rear covert 59a formed as one integral piece so as to fixedly mount the lens 11a therein and a union collar 60. The union collar 60 is tightly coupled to the cylindrical lens mounting frame 59 together by press-fitting the union collar 60 onto the tail covert 46a Further, the lens holder 57 is provided with three cam followers 41 arranged at regular angular intervals in a circumferential direction on the external wall of the union collar 60. Similarly to the cam followers 40 of the lens holder 45 for the second lens group 10a, each of the corn followers 41 comprises upper and lower cam follower rollers 53 and 54 which are supported for rotation a cam seat 52 by a set screw 51 engaged with a threaded boss 52 secured to the external wall of the union collar 60. As shown in FIG. 1D in detail, The upper and lower cam follower rollers 53 and 54 rotate independently within the circumferential zooming cam slot 39 of the zooming cam barrel 19 and the rectilinear axial guide slots 25 of the stationary barrel 14, respectively, so as thereby to allow smooth slide movement of the cam follower 41 in the circumferential zooming cam slot 39 and the rectilinear axial guide slots 25.

Each of lens holders 45 and 57 are formed in injection molding, not as one integral piece as it always has been in the past, but as two separate pieces in this embodiment. If these cylindrical lens mounting frame 46, 59 and union collar 47, 60 were formed as one integral piece, the mold needs a number of slide parts which are often causative of a cost rise and deterioration in injection accuracy. However, since these cylindrical lens mounting frame 46, 59 and union collar 47, 60 are formed separately as two independent pieces, the molds for these individual parts are made simple in configuration. This simple configuration of the molds leads to in a reduction of manufacturing cost. Furthermore, in the case where the zoom lens system has high group sensitivity on its optical design, the separate structure of the lens holder 45, 57 enables eccentricity adjustment of the lens 10a, 11a so as to realize fine optical axis alignment of the zoom lens system. Furthermore, these union collars 47 and 60 including the cam followers 40 and 41 may be identical to each other so as to reduce an initial cost of the zoom lens.

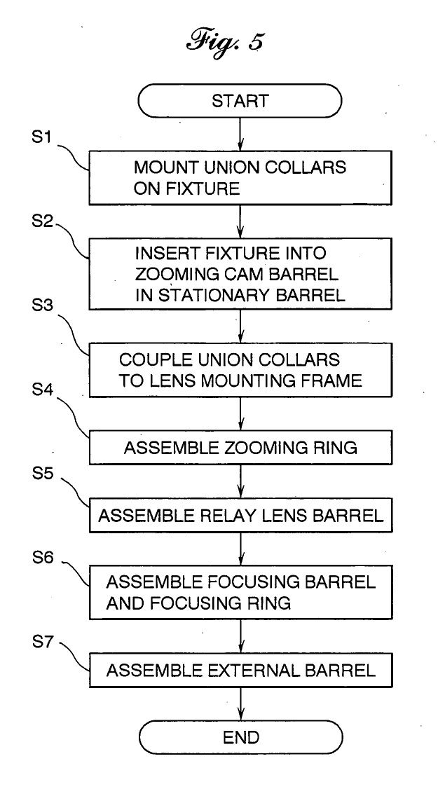

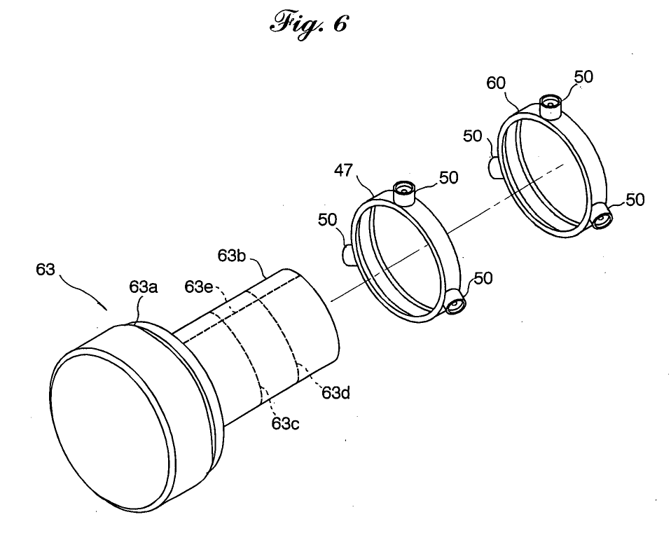

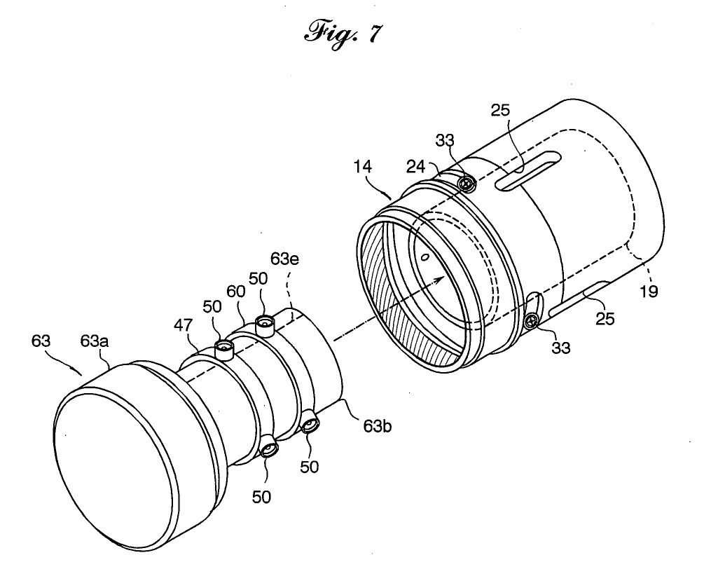

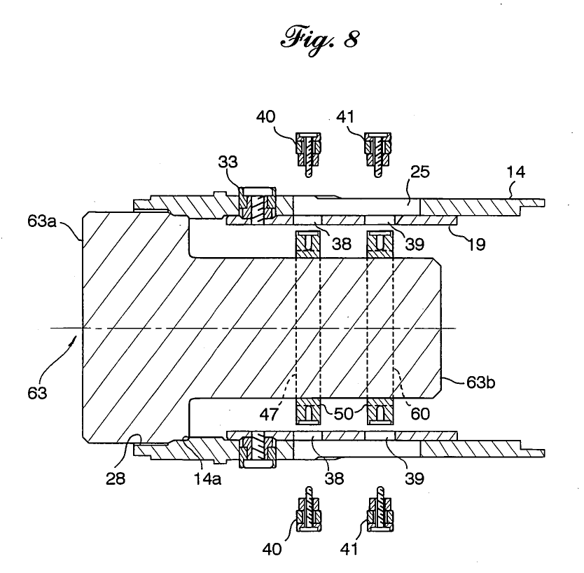

FIG. 5 shows a flowchart illustrating an assembling process of the zoom lens 3. In the assembling process, a fixture 63 is used. The fixture 63, that is made of plastic or metal and finished to high dimensional accuracy, comprises two cylindrical sections, namely a cylindrical positioning head 63a and a cylindrical shank 63b. The cylindrical positioning head 63a is shaped in conformity with the bore of the stationary barrel 14 so as to be snugly fitted into said cam barrel 14 from the front (on opposite side to the projector). As shown in FIG. 6, the cylindrical shank 63b is shaped so as to receive and snugly mount the union collars 47 and 60 thereon and has positioning lines, namely axial positioning lines 63c and 63d and a circumferential positioning line 63e drawn thereon. First of all, in first step S1, the union collars 47 and 60 with the threaded bosses 50 secured thereto are detachably mounted onto the cylindrical shank 63b of the fixture 63 in strict accordance with the axial positioning lines 63c and 63d, respectively, and adjusted in circumferential position by putting the threaded bosses 50 along the circumferential positioning line 63e as shown in FIG. 7. Subsequently, in step S2, the fixture 63 is inserted into the stationary barrel 14 in which the zooming cam barrel 19 is assembled beforehand until the positioning head 63a is snugly fitted in the stationary barrel 14 as shown in FIG. 8. The positioning head 63a at its rear edge is stopped by an internal shoulder 14a behind the internal helicoid threads 28 of the stationary barrel 14. In this state, the threaded bosses 50 of the union collars 47 and 60 are positioned in line with the zooming cam slots 38 and 39 of the zooming cam barrel 19, respectively, in an axial direction. Simultaneously, the fixture 60 is turned until the circumferential positioning line 63e is viewed through the rectilinear axial guide slot 25 of the stationary barrel 14. In this way, both union collars 47 and 60 are correctly positioned in the axial and circumferential directions. In this state, the cam followers 40 and 41 are assembled to the union collars 47 and 60, respectively, by screwing the set screws 51 into the threaded bosses 50. The use of the positioning fixture 63 makes it quite easy and precise to assemble the union collars 47 and 60 to the zooming cam barrel 19 in the stationary barrel 14. Furthermore, it is allowed to divert the union collars 47 and 60 to different zoom lenses when the zoom lens include lens groups different but similar in shape to the second and third lens groups 10 and 11, respectively. In such a case, it is suffice to modify the lens holders 45 and 57 only.

In step S3, after removing the positioning fixture 60 from the zooming cam barrel 19, the lenses 10a and 11a fixedly mounted in the lens mounting frame 46 and 59 of the lens holders 45 and 57, respectively, are inserted into the zooming cam barrel 19 from the front and the back, respectively, and then coupled to the union collars 47 and 60 together, respectively, by press fitting the tail coverts 46a and 59a into the union collars 47 and 60, respectively. Since the union collars 47 and 60 have been precisely positioned, the lenses 10a and 11a are consequently placed respectively in position. This is contributive to increasing optical performance of the lenses 10a and 11a as parts of the zoom lens system. Thereafter, in steps S4 through 7, the zoom ring 20, the relay lens barrel 16 with the relay lenses 12a and 12b fixedly mounted therein, the focusing barrel 15 and the focusing ring 18 are assembled to the zoom lens 3 preferably in this order.

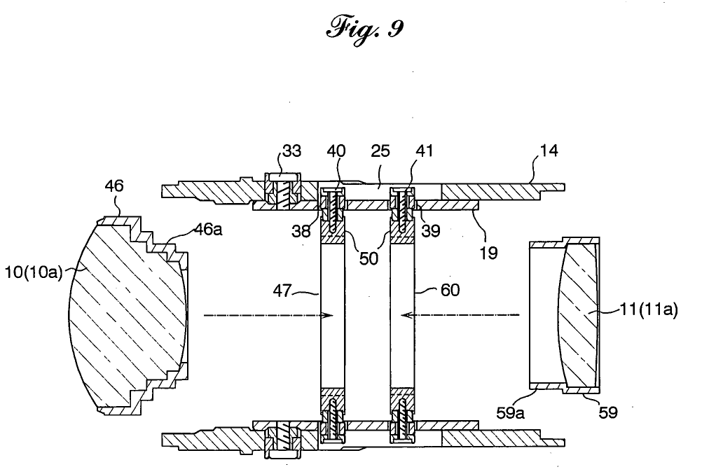

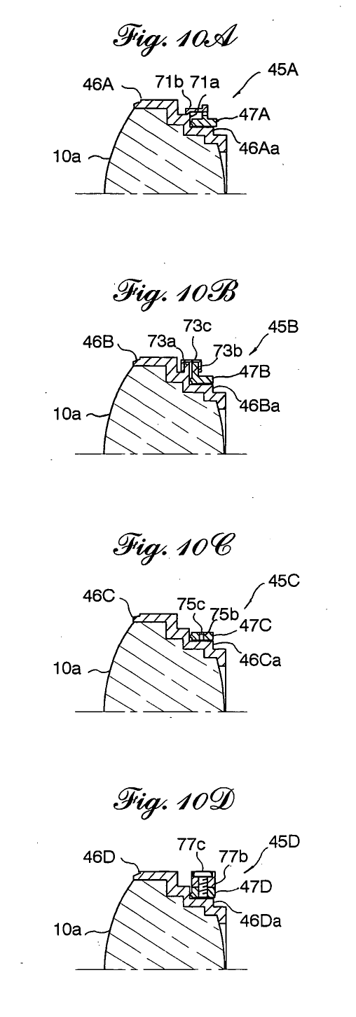

Although, in the above embodiment, coupling of the union collar 47 to the lens holder 45 together is performed by press fitting the union collar 47 onto the tail covert 46a of the lens mounting frame 46, alternative coupling means may be employed as shown in FIGS. 10(A) through 10(D).

As shown in FIG. 10A, a lens holder 45A for a lens 10a (a second lens group 10) comprises a generally cylindrically-shaped lens mounting frame 46A and a union collar 47A similar to the lens mounting frame 47 and union collar 47 of the previous embodiment, respectively. However, the lens mounting frame 46A having a tail covert 46Aa is provided with three retainer claws 71a formed as integral part extending radially outward from a rear edge thereof and arranged at regular angular intervals. The union collar 47A is provided with three flexible hooks 71b formed as integral parts extending forward and arranged at regular angular intervals alternately with cam followers (not shown). The union collar 47A is coupled to the lens mounting frame 46A together by engaging the flexible hooks 71b with the retainer claws 71a, respectively.

As shown in FIG. 10B, a lens holder 45B for a lens 10a (a second lens group 10) comprises a generally cylindrically-shaped lens mounting frame 46B and a union collar 47B similar to the lens mounting frame 47 and union collar 47 of the previous embodiment, respectively. The lens mounting frame 46B having a tail covert 46Ba is provided with three retainer projections 73a formed as integral part extending radially outward from a rear edge thereof and arranged at regular angular intervals. The union collar 47B is provided with three projections 73b formed as integral parts extending radially outward from a front edge thereof and arranged at regular angular intervals alternately with cam followers (not shown). The union collar 47B is coupled to the lens mounting frame 46A together by holding tight the projections 73a and 73b by resilient metal fasteners 73c.

As shown in FIG. 10C, a lens holder 45C for a lens 10a (a second lens group 10) comprises a generally cylindrically-shaped lens mounting frame 46C having a tail covert 46Ca that may be just the same as the union collar 46 of the previous embodiment and a union collar 47C similar to the union collar 47 of the previous embodiment. The union collar 47C is provided with three holes 75b arranged at regular angular intervals alternately with cam followers (not shown). The union collar 47C is coupled to the lens mounting frame 46A together by infusing adhesion bonds 75c into the holes 75b so as thereby to join the union collar 47C to the tail covert 46Ca of the lens mounting frame 46C with the adhesive bonds 75c.

As shown in FIG. 10D, a lens holder 45D for a lens 10a (a second lens group 10) comprises a generally cylindrically-shaped lens mounting frame 46D having a tail covert 46Da that may be just the same as the union collar 46 of the previous embodiment and a union collar 47D similar to the union collar 47 of the previous embodiment. The union collar 47D is provided with three bosses with internal threads 77b preferably formed as integral parts extending radially outward and arranged at regular angular intervals alternately with cam followers (not shown). The union collar 47D is coupled to the lens mounting frame 46D together by fastening set screws 77c into the boss 77b until the set screws 77c bears against the tail covert 46Da of the lens mounting frame 46D.

In the case of using an adhesion bond or set screws in order to couple the lens mounting frame and the union collar together, it is preferred to form slots or bores as access ways to the union collar in both stationary barrel and zooming cam barrel.

Although, the above description has been directed to the zoom lens for use with projectors, nevertheless, the zoom lens of the present invention is suitably used in combination with optical instruments such as photographic cameras.

It is to be understood that although the present invention has been described with regard to a preferred embodiments thereof, various other embodiments and variants may occur to those skilled in the art, which are within the scope and spirit of the invention, and such other embodiments and variants are intended to be covered by the following claims.

What is claimed is:

1. A lens device including a plurality of lens groups, a lens holder for holding each said lens group, a cam barrel for receiving said lens holder therein so as to allow axial movement of said lens holder, and a cam mechanism comprising cam slots formed in said cam barrel and cam followers provided on said lens holder in slide engagement with said cam slots, respectively, through which rotation of said cam barrel causes said axial movement of said lens holder, said lens holder comprising:
a lens mounting frame for fixedly mounting said lens group therein; and
a union collar fixedly coupled to said lens mounting frame;
wherein said cam followers are fixed to said union collar.

2. The lens device as defined in claim 1, wherein said union color is coupled to said lens mounting frame by press-fitting.

3. The lens device as defined in claim 1, and further comprising coupling means for coupling said union color and said lens mounting frame together, said coupling means comprising retainer claws formed as integral part extending radially outward from said lens mounting frame and flexible hooks formed as integral parts extending forward from said union collor, wherein said union color and said lens mounting frame are coupled together by bringing said flexible hook and said retainer claws into engagement, respectively.

4. The lens device as defined in claim 3, wherein both said retainer claws and said flexible hooks are arranged at regular angular intervals.

5. The lens device as defined in claim 1, and further comprising coupling means for coupling said union color and said lens mounting frame together, said coupling means comprising projections formed as integral part extending radially outward from both said lens mounting frame and said union collar, and resilient fasteners for fastening respective pairs of said projections of said lens mounting frame and said union collar so as thereby to couple said union color and said lens mounting frame

6. The lens device as defined in claim 5, wherein said projections of both said lens mounting frame and said union collar are arranged at regular angular intervals.

7. The lens device as defined in claim 1, wherein said union color is coupled to said lens mounting frame with an adhesion bond.

8. The lens device as defined in claim 1, wherein said union color is coupled to said lens mounting frame with set screws.

9. An assembling process for assembling a lens device including a plurality of lens groups each of which comprises at least one lens element, lens holders for holding said lens groups, respectively, each said lens holder comprising a lens mounting frame for fixedly mounting said lens group therein and a union collar provided with a plurality of cam followers extending radially outwardly and coupled to said lens mounting frame, and a cam barrel provided with a plurality of cam slots which receives said lens holder so as to cause axially movement of said lens holder through slide engagement between said cam followers and said cam slots, respectively, when said cam barrel rotates, said assembling process comprising the steps of:
assembling said union collars into said cam barrel; and
fixedly coupling said lens mounting frames with said lens groups fixedly mounted therein, respectively, and said union collars together, respectively.

10. The assembling process for assembling a lens device as defined in claim 9, wherein said union colors are detachably mounted on a fixture assembled in predetermined positions, respectively, and assembled into said cam barrel by inserting and snugly fitting said fixture in predetermined axial position in said cam barrel.
